(19) United States
(12) Patent Application Publication
(10) Pub. No.: US 2006/0029754 A1
(43) Pub. Date: Feb. 9, 2006

(54) Coated substrate with improved solar control properties

(76) Inventors: Paul A. Medwick, Glenshaw, PA (US); Andrew V. Wagner, Pittsburgh, PA (US)

Correspondence Address: PPG INDUSTRIES, INC.;INTELLECTUAL PROPERTY DEPT., ONE PPG PLACE, PITTSBURGH, PA, 15272, US

(21) Appl. No.: 10/912,718

(22) Filed: Aug. 5, 2004

(51) Int. Cl. E06B 3/24; B32B 17/06; B32B 15/04; B32B 9/00; B32B 19/00; B05D 5/06

(52) U.S. Cl. 428/34; 428/432; 428/469; 428/701; 428/702; 427/162; 427/160

(57) ABSTRACT

A coated substrate is disclosed. The coated substrate includes a substrate; a first dielectric layer overlying the substrate having a total thickness greater than 290 Å; a first infrared-reflective metal layer having a thickness ranging from 100 Å to 130 Å overlying the first dielectric layer; a first primer layer having a thickness ranging from 0.5 Å to 60 Å overlying the first infrared-reflective metal layer; a second dielectric layer overlying the first primer layer having a total thickness ranging from 680 Å to 870 Å; a second infrared-reflective metal layer having a thickness ranging from 115 Å to 150 Å overlying the second dielectric layer; a second primer layer having a thickness ranging from 0.5 Å to 60 Å overlying the second dielectric layer; and a third dielectric layer having a total thickness ranging from 190 Å to 380 Å overlying the second primer layer.

### FIELD OF THE INVENTION

The present invention relates to substrates coated with multi-layer coating compositions.

### BACKGROUND OF THE INVENTION

Substrates such as glass and steel are used to make buildings, appliances, cars, etc. Oftentimes, it is necessary to apply a functional coating(s) over the substrate to obtain the desired performance. Examples of functional coatings include electroconductive coatings, photocatalytic coatings, thermal management coatings, hydrophilic coatings, etc.

A thermal management coating (examples include low emissivity coatings and/or solar control coatings) can be applied on a glass substrate(s) used to make a window for a building to manipulate the thermal insulating, solar control, and/or aesthetic properties of the window. By manipulating the thermal insulating and solar control properties of one or more window(s) in a structure, the temperature inside the structure as well as the amount of light inside the structure can be effectively managed. One class of thermal management coating is made up of at least one infrared-reflective metal layer sandwiched between layers of dielectric material. The specific design of the thermal management coating is driven by the degree of solar control and/or thermal insulation properties required for the application as well as aesthetic considerations.

The present invention provides a substrate coated with a novel thermal management coating. The coated substrate of the invention can exhibit a combination of thermal insulating properties, solar control properties and/or aesthetic properties that are desirable in the marketplace.

### SUMMARY OF THE INVENTION

In a non-limiting embodiment, the present invention is a coated substrate comprising: a substrate; a first dielectric layer overlying the substrate having a total thickness greater than 290 Å; a first infrared-reflective metal layer having a thickness ranging from 100 Å to 130 Å overlying the first dielectric layer; a first primer layer having a thickness ranging from 0.5 Å to 60 Å overlying the first infrared-reflective metal layer; a second dielectric layer overlying the first primer layer having a total thickness ranging from 680 Å to 870 Å; a second infrared-reflective metal layer having a thickness ranging from 115 Å to 150 Å overlying the second dielectric layer; a second primer layer having a thickness ranging from 0.5 Å to 60 Å overlying the second infrared-reflective metal layer; and a third dielectric layer having a total thickness ranging from 190 Å to 380 Å overlying the second primer layer.

In another non-limiting embodiment, the present invention is a coated substrate comprising: a substrate; a first dielectric layer having a total thickness greater than 290 Å overlying the substrate comprising: a layer of zinc stannate overlying the substrate; and a layer of zinc oxide overlying the layer of zinc stannate; a first silver layer having a thickness ranging from 100 Å to 130 Å overlying the first dielectric layer; a first layer of titanium containing material having a thickness ranging from 0.5 Å to 60 Å overlying the first silver layer; a second dielectric layer having a thickness ranging from 680 Å to 870 Å overlying the first layer of titanium containing material comprising: a layer of zinc oxide overlying the first layer of titanium containing material; a layer of zinc stannate overlying the layer of zinc oxide; and a layer of zinc oxide overlying the layer of zinc stannate; a second silver layer having a thickness ranging from 115 Å to 150 Å overlying the second dielectric layer; a second layer of titanium containing material having a thickness ranging from 0.5 Å to 60 Å overlying the second silver layer; and a third dielectric layer having a thickness ranging from 190 Å to 380 Å overlying the second layer of titanium containing material comprising: a layer of zinc oxide overlying the second layer of titanium containing material and a layer of zinc stannate overlying the layer of zinc oxide of the third dielectric layer.

In yet another non-limiting embodiment, the invention is a method for making a coated substrate comprising: depositing a first dielectric layer having a thickness greater than 290 Å over the substrate; depositing a first infrared-reflective metal layer having a thickness ranging from 100 Å to 130 Å over the first dielectric layer; depositing a first primer layer having a thickness ranging from 0.5 Å to 60 Å over the first infrared-reflective metal layer; depositing a second dielectric layer having a thickness ranging from 680 Å to 870 Å over the first primer layer; depositing a second infrared-reflective metal layer having a thickness ranging from 115 Å to 150 Å over the second dielectric layer; depositing a second primer layer having a thickness ranging from 0.5 Å to 60 Å over the second infrared-reflective metal layer; and depositing a third dielectric layer having a thickness ranging from 190 Å to 380 Å over the second primer layer.

### DESCRIPTION OF THE INVENTION

All numbers expressing dimensions, physical characteristics, quantities of ingredients, reaction conditions, and the like used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Moreover, all ranges disclosed herein are to be understood to encompass any and all sub-ranges subsumed therein. For example, a stated range of “1 to 10” should be considered to include any and all sub-ranges between (and inclusive of) the minimum value of 1 and the maximum value of 10; that is, all sub-ranges beginning with a minimum value of 1 or more and ending with a maximum value of 10 or less, e.g., 1.0 to 7.8, 3.0 to 4.5, 6.3 to 10.0.

As used herein, spatial or directional terms, such as “left”, “right”, “inner”, “outer”, “above”, “below”, “top”, “bottom”, and the like, are understood to encompass various alternative orientations and, accordingly, such terms are not to be considered as limiting.

As used herein, the terms “on”, “applied on/over”, “formed on/over”, “deposited on/over”, “overlay” and “provided on/over” mean formed, deposited, or provided on but not necessarily in contact with the surface. For example, a coating layer “formed over” a substrate does not preclude the presence of one or more other coating layers of the same or different composition located between the formed coating layer and the substrate. For instance, the substrate can include a conventional coating such as those known in the art for coating substrates, such as glass or ceramic.

As used herein, the term “minor film” refers to a specific film composition which is described in the specification. The term is not descriptive of the location of the film in a coating stack or in any specific coating layer within the coating stack. Further, the term is not descriptive of any thickness.

As used herein, the term “major film” refers to a specific film composition which is described in the specification. The term is not descriptive of the location of the film in the coating stack or in any specific coating layer within the coating stack. Further, the term is not descriptive of any thickness. In certain embodiments, the minor film can have a thickness that is greater than that of the major film.

In a non-limiting embodiment, the present invention is a substrate coated with a multi-layer coating composition comprising a first dielectric layer, a first infrared-reflective metal layer, a first primer layer, a second dielectric layer, a second infrared-reflective metal layer, a second primer layer, and a third dielectric layer. The first dielectric layer can have a single film or a multiple film configuration. In a non-limiting embodiment of the invention, the first dielectric layer is a single film comprising a material having refractive index greater than or about equal to 2 in the visible portion of the electromagnetic spectrum. Non-limiting examples of such materials include oxides of metals or metal alloys such as zinc oxide, tin oxide, zinc/tin oxide, zinc stannate, zinc aluminum oxide, indium tin oxide, titanium oxide, tantalum oxide, and bismuth oxide; and dielectric nitrides such as silicon nitride and aluminum nitride; as well as alloys and mixtures thereof.

In another non-limiting embodiment of the invention, the first dielectric layer is a multiple film configuration comprising: (1) a major film and (2) a minor film. The major film of the first dielectric layer overlays the substrate and comprises a material having an index of refraction greater than or equal to 2 in the visible portion of the electromagnetic spectrum. Non-limiting examples of suitable materials are provided in the preceding paragraph. Typically, the major film comprises a chemically and thermally resistant, dielectric material such as, but not limited to, zinc oxide, tin oxide, zinc/tin alloy oxide, silicon nitride, alloys and mixtures thereof.

In one non-limiting embodiment of the present invention, the major film can comprise a zinc/tin alloy oxide. The zinc/tin alloy oxide can be obtained by using magnetron sputter vacuum deposition (“MSVD”) to sputter a cathode comprising an alloy of zinc and tin that can comprise zinc and tin in proportions of 10 wt. % to 90 wt. % zinc and 90 wt. % to 10 wt. % tin. In a non-limiting embodiment of the invention where the major film of the first dielectric layer comprises a zinc/tin alloy oxide, the major film can be comprised of zinc stannate. The term “zinc stannate” refers to a composition of

ZnXSn1—XO2—X (Formula 1) where x is greater than 0 but less than 1. If x=⅔, for example, the zinc stannate formed would be represented by Zn2/3Sn1/3O4/3 which is commonly described as “Zn2SnO4”. A zinc stannate containing coating has one or more of films according to Formula 1 in a predominant amount.

The minor film of the first dielectric layer overlays the major film of the first dielectric layer. The minor film should have an index of refraction that is close to the index of refraction of the major film. This is because the minor film and the major film work in concert to give the first dielectric layer a single optical effect. Suitable materials for the minor film of the first dielectric layer include, but are not limited to, zinc oxide, tin oxide, zinc aluminum oxide, indium tin oxide, titanium oxide, silicon nitride, tantalum pentoxide, aluminum nitride and alloys and mixtures thereof.

The total thickness of the first dielectric layer is greater than 290 Å. For example, the total thickness of the first dielectric layer can range from 290 Å to 350 Å or 295 Å to 340 Å. As used herein, “thickness” refers to the physical, or “geometrical”, thickness of a given layer or film.

The first dielectric layer can be deposited using conventional techniques such as chemical vapor deposition (“CVD”), spray pyrolysis, and MSVD. If a coating layer is made up of more than one discrete films, the described deposition techniques can be used to deposit some or all of the films that make up the total coating layer.

Suitable CVD methods of deposition are described in the following references, which are hereby incorporated by reference: U.S. Pat. Nos. 4,853,257; 4,971,843; 5,536,718; 5,464,657; 5,599,387; and 5,948,131.

Suitable spray pyrolysis methods of deposition are described in the following references, which are hereby incorporated by reference: U.S. Pat. Nos. 4,719,126; 4,719,127; 4,111,150; and 3,660,061.

Suitable MSVD methods of deposition are described in the following references, which are hereby incorporated by reference: U.S. Pat. Nos. 4,379,040; 4,861,669; and 4,900,633.

The first infrared-reflective metal layer overlays the minor film of the first dielectric layer. The first infrared-reflective metal layer can comprise one or more noble metals such as silver, gold, copper, platinum, iridium, osmium, and alloys and mixtures thereof. The thickness of the first infrared-reflective metal layer can range from 100 Å to 130 Å for example from 105 Å to 125 Å, or from 110 Å to 120 Å.

The first infrared-reflective metal layer can be deposited using any of the methods described above in reference to the first dielectric layer. When the minor film of the first dielectric layer comprises zinc oxide and the infrared-reflective metal layer comprises silver, the atoms in the first infrared-reflective metal layer orient themselves in a beneficial way as described in U.S. Pat. No. 5,821,001, which is hereby incorporated by reference.

The first primer layer overlays the first infrared-reflective metal layer. The first primer layer comprises an oxygen-capturing or oxygen-reactive material, such as transition-metal containing materials. For example, suitable materials for the primer layer include a titanium containing material, a zirconium containing material, an aluminum containing material, a nickel containing material, a chromium containing material, a hafnium containing material, a copper containing material, a niobium containing material, a tantalum containing material, a vanadium containing material, an indium containing material, etc. The first primer layer acts as a sacrificial layer to protect the first infrared-reflective metal layer during subsequent processing steps. The first primer layer is sacrificial in the sense that it reacts with oxygen that is present as a result of subsequent processing steps to prevent the oxygen from reacting with the first infrared-reflective metal layer and hence adversely affect the final properties of the coated substrate.

The first primer layer can be deposited using any of the methods described above in reference to the first dielectric layer. The first primer layer is deposited as a metal. However, after the primer layer is deposited, it is either partially or completely oxidized depending on the specific deposition conditions. As is well known in the art, the thickness of the partially or completely oxidized primer is greater than the thickness of the primer as originally deposited. As used herein, the phrase “thickness of the (first) primer layer” refers to the thickness of the partially or completely oxidized (first) primer layer.

Depending upon whether or not the coating of the present invention will be heat treated, the thickness of the first primer layer varies. For example, the coating may be applied to a glass substrate and have to undergo standard heat treatments associated with bending or tempering.

In a non-limiting embodiment of the invention in which the coating of the present invention will not be heat treated, the thickness of the first primer layer can range from 0.5 Å to 60 Å, for example from 12 Å to 30 Å, or from 15 Å to 25 Å. In a non-limiting embodiment of the invention in which the coating of the present invention will be heat treated, the thickness of the first primer layer can range from 0.5 Å to 60 Å, for example, from 25 Å to 55 Å or from 25 Å to 45 Å. When the coating will be heat treated, the first primer layer has to be thicker than when the coating is not heated because heat treatment of the coating drives the oxidation of the primer layer.

A second dielectric layer overlays the first primer layer. In a non-limiting embodiment of the invention, the second dielectric layer is a single film comprising a material having a refractive index greater than or equal to 2 in the visible portion of the electromagnetic spectrum. Non-limiting examples of suitable materials include oxides of metals or metal alloys such as zinc oxide, tin oxide, zinc/tin oxide, zinc stannate, zinc aluminum oxide, indium oxide, indium tin oxide, titanium oxide, tantalum oxide, and bismuth oxide as well as dielectric nitrides such as silicon nitride, aluminum nitride as well as alloys and mixtures thereof. In another non-limiting embodiment of the invention, the second dielectric layer is a multiple film configuration comprising a major film sandwiched between two minor films. The minor films and the major film can comprise the same materials as described above in reference to the first dielectric layer. The two minor films—a first minor film that lies under the major film and a second minor film that overlays the major film—can be made of the same or different materials.

The total thickness of the second dielectric layer can range from 680 Å to 870 Å, for example 700 Å to 850 Å or 720 Å to 820 Å. The second dielectric layer can be deposited using any of the methods described above in reference to the first dielectric layer.

A second infrared-reflective metal layer overlays the second dielectric layer. The second infrared-reflective metal layer is comprised of the same materials as described above in reference to the first infrared-reflective metal layer. The thickness of the second infrared-reflective metal layer can range from 115 Å to 150 Å for example from 124 Å to 130 Å, or from 126 Å to 128 Å. The second infrared-reflective layer can be deposited using any of the methods described above in reference to the first dielectric layer.

A second primer layer overlays the second infrared-reflective metal layer. The second primer layer is comprised of the same materials as described above in reference to the first primer layer. The thickness of the second primer layer is as described above in reference to the first primer layer. Further, as discussed above, the second primer layer will generally be thicker if the coating will be subjected to heat treatment. The second primer layer can be deposited using any of the methods described above in reference to the first dielectric layer.

A third dielectric layer overlays the second primer layer. In a non-limiting embodiment of the invention, the third dielectric layer is a single film comprised of a material having a refractive index greater than or about equal to 2 in the visible portion of the electromagnetic spectrum. Non-limiting examples of suitable materials include oxides of metals or metal alloys such as zinc oxide, tin oxide, zinc/tin oxide, zinc stannate, zinc aluminum oxide, indium oxide, indium tin oxide, titanium oxide, tantalum oxide, and bismuth oxide as well as dielectric nitrides such as silicon nitride, aluminum nitride as well as alloys and mixtures thereof. In another non-limiting embodiment of the invention, the third dielectric layer is a multiple film configuration comprising a major film and a minor film. In this embodiment, the minor film of the third dielectric layer overlays the second primer layer and the major film overlays the minor film. The minor film and the major film are comprised of the same materials as described above in reference to the first dielectric layer.

The total thickness of the third dielectric layer can range from 190 Å to 380 Å, for example 200 Å to 350 Å or 220 Å to 320 Å. The third dielectric layer can be deposited using any of the methods described above in reference to the first dielectric layer.

Optionally, a protective overcoat overlays the third dielectric layer. Examples of suitable protective overcoats, include, but are not limited to, a layer of titanium oxide as disclosed in U.S. Pat. No. 4,716,086, the disclosure of which is incorporated herein by reference. In a non-limiting embodiment of the invention, the thickness of the protective overcoat can range from 30 Å to 100 Å, for example, from 30 Å to 80 Å, or from 30 Å to 60 Å.

Suitable substrates for the present invention include, but are not limited to, materials that transmit visible light such as glass and plastics. In a non-limiting embodiment of the invention, the glass is untempered glass as is well known in the art. In another non-limiting embodiment of the invention, the glass is tempered glass as is well known in the art. The tempering can be accomplished using standard techniques. The tempered glass can be used to make a window pane.

In yet another non-limiting embodiment of the invention, one or more glass substrates according to the present invention are used to form an insulating glass unit (“IG unit). Although the present invention is not limited to any specific construction of an IG unit, a typical double-glazed IG unit is made up of an inner glass pane spaced apart from an outer glass pane by a spacer as is well known in the art. Suitable IG units are described in U.S. Pat. No. 5,655,282, which is hereby incorporated by reference.

The present invention is illustrated by the following non-limiting examples.

### EXAMPLES

For testing purposes, two samples—Example 1 (a non-temperable product) and Example 2 (a temperable product) were prepared by coating a float glass substrate using a production in-line glass vacuum coater using an MSVD process. The process parameters such as gaseous environments and pressures used in the MSVD coater were typical of those used for other commercial MSVD deposited coatings. The compositions of the coating configurations for Example 1 and Example 2 are described in the following paragraph and the thicknesses of the described coating layers are shown in Table 1. The layer thicknesses of the exemplary coating configurations were determined using spectroscopic ellipsometry.

Each deposited coating was a multi-layer coating composition comprising a first dielectric layer overlying substrate. The first dielectric layer was comprised of a major film and a minor film. The major film of the first dielectric layer overlaid the substrate and was comprised of zinc stannate. The minor film of the first dielectric layer overlaid the major film of the first dielectric layer and was comprised of zinc oxide. A first infrared-reflective metal layer comprised of silver overlaid the first dielectric layer. A first primer layer deposited as titanium that subsequently either partly or completely oxidized overlaid the first infrared-reflective metal layer. A second dielectric layer comprised of two minor films sandwiching a major film overlaid the first primer layer. Both minor films were comprised of zinc oxide. The major film was comprised of zinc stannate. A second infrared-reflective metal layer comprised of silver overlaid the second dielectric layer. A second primer layer deposited as titanium that subsequently either partly or completely oxidized overlaid the second infrared-reflective metal layer. A third dielectric layer comprised of a minor film and a major film overlaid the second primer layer. The minor film of the third dielectric layer overlaid the second primer layer and was comprised of zinc oxide. The major film of the third dielectric layer overlaid the minor film of the third dielectric layer and was comprised of zinc stannate. A layer of protective overcoat comprised of titanium containing materials overlaid the third dielectric layer.

TABLE 1
Layer Thicknesses for the Exemplary Coating Configurations

| Coating Layers | Ex. 1 [Å] | Ex. 2 [Å] |
|---|---|---|
| major film of the first dielectric layer | 186 | 184 |
| minor film of the first dielectric layer | 90 | 90 |
| first infrared-reflective metal layer | 116 | 118 |
| first primer layer | 20 | 51 |
| lower minor film of the second dielectric layer | 90 | 90 |
| major film of the second dielectric layer | 612 | 584 |
| upper minor film of the second dielectric layer | 90 | 90 |
| second infrared-reflective metal layer | 130 | 128 |
| second primer layer | 20 | 51 |
| minor film of the third dielectric layer | 90 | 70 |
| major film of the third dielectric layer | 162 | 148 |
| protective overcoat | 55 | 91 |

Prior to being tested, the substrate coated with Example 2 was heated in a box furnace having a set point of approximately 1300° F. for five minutes. After five minutes of heating, the temperature of the coated surface was approximately 1185° F.

The spectral properties of the examples were characterized using a Perkin-Elmer Lambda 9 UV/VIS/NIR spectrophotometer over the ultraviolet, visible, and near infrared regions of the electromagnetic spectrum. Table 2 shows near-normal incidence chromaticity data for Examples 1 and 2. The chromaticity data is referenced to CIE L*, a*, b* chromaticity space for Illuminant D65, 10 degree standard observer. The following is a description of the three aesthetic properties shown in Table 2. T (L*, a*, b*) connotes the chromaticity coordinates of transmitted light (angle of incidence=0° from normal); Rf (L*, a*, b*) connotes the chromaticity coordinates of light reflected from the coated surface of the sample; and Rg (L*, a*, b*) connotes the chromaticity coordinates of light reflected from the uncoated surface of the sample (for both Rf and Rg reflectances, the angle of incidence=8° from normal). Thus, nine numbers in total are used to describe the near-normal incidence aesthetic properties of the monolithic coated substrate. The phrase “near-normal incidence” is well known in the art to mean looking essentially straight at an object.

TABLE 2
Transmitted and Reflected Aesthetics of a Monolithic
Coated Substrate According to the Present Invention

| Exam- | | | | | | | | | |
|---|---|---|---|---|---|---|---|---|---|
| ple | TL* | Ta* | Tb* | RfL* | Rfa* | Rfb* | RgL* | Rga* | Rgb* |
| 1 | 90.77 | −2.47 | 1.36 | 31.22 | −9.33 | 4.08 | 33.78 | 0.45 | −4.31 |
| 2 | 91.98 | −2.04 | 1.94 | 31.21 | −7.27 | 4.61 | 33.86 | 1.44 | −4.24 |

Table 3 shows selected aesthetic and thermal management performance data for a double-glazed insulated glass (“IG”) unit configuration containing a glass substrate coated with Example 1 and Example 2, respectively. In the IG unit configuration, the coating of the invention is on an outboard clear glass light pane with an inboard clear glass light pane. The performance properties in the table shown below were calculated using Lawrence Berkeley National Lab's WINDOW 5.2.17 algorithm based on the measured spectrophotometric data. To calculate the performance data for the double glazed IG unit, the WINDOW 5.2.17 algorithm required the following information: the thickness of the outboard light pane as well as its spectral transmittance and reflectance; emissivities of the outboard pane's major surfaces as well as the thermal properties (e.g., thermal conductivity and specific heat) of the outboard pane; the thickness of the inboard light pane as well as its spectral transmittance and reflectance; emissivities of the inboard pane's major surfaces as well as the thermal properties (e.g., thermal conductivity and specific heat) of the inboard pane; the distance between the outboard light pane and the inboard light pane; the type of gas fill used in the space between the panes; and what surface(s) of the IG unit are coated. If a given pane is coated, the spectral properties (i.e., transmittance and reflectance) of the coated pane are used to determine the net aesthetic and thermal management properties of the IG unit.

For the outboard light pane, the following information was entered: clear glass, 0.223 inch thick. For the inboard light pane, the following information was entered: clear glass, 0.223 inch thick. For airspace width, the following information was entered: 0.5 inch. For airspace gas fill, the following information was entered: air. And for information regarding which surface(s) of the IG unit was coated, the following was entered: #2 (i.e., inboard surface of outboard light pane).

TABLE 3
Aesthetic and Thermal Management Properties of Double-Glazed
IG Units According to the Present Invention

| Example | Example 1 | Example 2 |
|---|---|---|
| Tvis¹ [%] | 68.2 | 70.9 |
| Rvis (exterior)² [%] | 12.9 | 13.4 |
| Rvis (interior)³ [%] | 13.9 | 13.9 |
| TSET⁴ [%] | 31.6 | 32.5 |
| TSER⁵ (exterior) [%] | 29.1 | 30.7 |
| TSER⁶ (interior) [%] | 30.8 | 32.2 |
| SC⁷ | 0.42 | 0.43 |
| SHGC⁸ | 0.37 | 0.38 |
| LSG⁹ Ratio | 1.84 | 1.87 |
| U-Value¹⁰ [Btu/hr-ft2-° F.] | 0.30 | 0.29 |

¹Transmitted visible light.
²Reflected visible light as viewed from the exterior.
³Reflected visible light as viewed from the interior.
⁴Total solar energy transmitted.
⁵Total solar energy reflected from the exterior.
⁶Total solar energy reflected from the interior.
⁷Shading coefficient. The SC value was calculated using National Fenestration Research Council (NFRC) summer, daytime standard conditions.
⁸Solar Heat Gain Coefficient. The SHGC value was calculated using NFRC summer, daytime standard conditions.
⁹Light to Solar Gain Ratio. The LSG value is the ratio of Tvis (expressed as a decimal) to the SHGC. The calculated LSG Ratio references NFRC summer, daytime standard conditions.
¹⁰The U-value was calculated using NFRC winter, nighttime standard conditions.

### CONCLUSION

Table 2 shows the transmitted and reflected aesthetics of a monolithic substrate coated according to the present invention. Table 3 shows the properties that can be achieved when a glass substrate according to the present invention is incorporated in the described insulating glass unit. The properties are as follows: Tvis of greater than or equal to 68.2%; Rvis (exterior) of less than or equal to 13.4%; Rvis (interior) of less than or equal to 13.9%; TSET of less than or equal to 32.5%; TSER (exterior) of greater than or equal to 29.1%; TSER (interior) of greater than or equal to 30.8%; SC of less than or equal to 0.43; SHGC of less than or equal to 0.38; LSG Ratio of greater than or equal to 1.84; and U-Value of less than or equal to 0.30 Btu/hr-ft2-° F.

It will be readily appreciated by those skilled in the art that modifications may be made to the invention without departing from the concepts disclosed in the foregoing description. Such modifications are to be considered as included within the scope of the invention. Accordingly, the particular embodiments described in detail hereinabove are illustrative only and are not limiting as to the scope of the invention, which is to be given the full breadth of the appended claims and any and all equivalents thereof.

1. A coated substrate comprising:
a. a substrate;
b. a first dielectric layer overlying the substrate having a total thickness greater than 290 Å;
c. a first infrared-reflective metal layer having a thickness ranging from 100 Å to 130 Å overlying the first dielectric layer;
d. a first primer layer selected from a titanium containing material, a zirconium containing material, an aluminum containing material, a hafnium containing material, a copper containing material, a niobium containing material, a tantalum containing material, a vanadium containing material, and an indium containing material having a thickness ranging from 0.5 Å to 60 Å overlying the first infrared-reflective metal layer;
e. a second dielectric layer overlying the first primer layer having a total thickness ranging from 680 Å to 800 Å;
f. a second infrared-reflective metal layer having a thickness ranging from 115 Å to 150 Å overlying the second dielectric layer;
g. a second primer layer selected from a titanium containing material, a zirconium containing material, an aluminum containing material, a hafnium containing material, a copper containing material, a niobium containing material, a tantalum containing material, a vanadium containing material, and an indium containing material having a thickness ranging from 0.5 Å to 60 Å overlying and in direct contact with the second infrared-reflective metal layer; and
h. a third dielectric layer having a total thickness ranging from 190 Å to 380 Å overlying the second primer layer, wherein there is no NiOx layer between the first infrared-reflective metal layer and the second dielectric layer or over the second infrared-reflective metal.

2. The coated substrate according to claim 1 wherein the first, second, and third dielectric layer is a single film comprised of a material having a refractive index greater than or equal to 2 in the visible portion of the electromagnetic spectrum.

3. The coated substrate according to claim 2 wherein first, second, and third dielectric layer is a single film selected from zinc oxide, tin oxide, zinc/tin oxide, zinc stannate, zinc aluminum oxide, indium oxide, indium tin oxide, titanium oxide, tantalum oxide, bismuth oxide, silicon nitride and aluminum nitride as well as alloys and mixtures thereof.

4. (canceled)

5. (canceled)

6. The coated substrate according to claim 1, wherein the first dielectric layer comprises:
a major film selected from zinc oxide, tin oxide, zinc/tin oxide, zinc stannate, zinc aluminum oxide, indium oxide, indium tin oxide, titanium oxide, tantalum oxide, bismuth oxide, silicon nitride, aluminum nitride as well as alloys and mixtures thereof overlying the substrate; and
a minor film selected from zinc oxide, tin oxide, zinc/tin oxide, zinc stannate, zinc aluminum oxide, indium oxide, indium tin oxide, titanium oxide, tantalum oxide, bismuth oxide, silicon nitride, aluminum nitride as well as alloys and mixtures thereof overlying the major film.

7. The coated substrate according to claim 6, wherein the minor film is zinc oxide.

8. The coated substrate according to claim 1, wherein the second dielectric layer comprises:
a. a lower minor film selected from zinc oxide, tin oxide, zinc/tin oxide, zinc stannate, zinc aluminum oxide, indium oxide, indium tin oxide, titanium oxide, tantalum oxide, bismuth oxide, silicon nitride, aluminum nitride as well as alloys and mixtures thereof overlying the first primer layer;
b. major film selected from zinc oxide, tin oxide, zinc/tin oxide, zinc stannate, silicon nitride, aluminum nitride as well as alloys and mixtures thereof overlying the lower minor film of the second dielectric layer; and
c. an upper minor film selected from zinc oxide, tin oxide, zinc/tin oxide, zinc stannate, zinc aluminum oxide, indium oxide, indium tin oxide, titanium oxide, tantalum oxide, bismuth oxide, silicon nitride, aluminum nitride as well as alloys and mixtures thereof overlying the major film.

9. The coated substrate according to claim 8 wherein the lower minor film and/or the upper minor film comprise zinc oxide.

10. The coated substrate according to claim 1, wherein the third dielectric layer comprises:
a. a minor film selected from zinc oxide, tin oxide, zinc/tin oxide, zinc stannate, zinc aluminum oxide, indium oxide, indium tin oxide, titanium oxide, tantalum oxide, bismuth oxide, silicon nitride, aluminum nitride as well as alloys and mixtures thereof overlying the second primer layer; and
b. a major film selected from zinc oxide, tin oxide, zinc/tin oxide, zinc stannate, zinc aluminum oxide, indium oxide, indium tin oxide, titanium oxide, tantalum oxide, bismuth oxide, silicon nitride, aluminum nitride as well as alloys and mixtures thereof overlying the major film.

11. The coated substrate according to claim 10 wherein the minor film comprises zinc oxide.

12. The coated substrate according to claim 1, wherein the first and second infrared-reflective metal layers are selected from gold, copper, silver, and alloys and mixtures thereof.

13. The coated substrate according to claim 1, wherein the substrate is glass.

14. The coated substrate according to claim 1, wherein when the coated substrate is placed in an insulating glass (IG) unit having a configuration as described in the following manner: an outboard light pane having a major surface made of 0.223 inch thick clear glass spaced 0.5 inch apart from and facing an inboard light pane made of clear glass having a nominal thickness of 0.223 inch; a space between the light panes filled with air; and the coating applied on the major surface of the outboard light pane nearest to and facing the inboard light pane; and the IG unit exhibits at least one of the following properties: Tvis of greater than or equal to 68.2%; Rvis (exterior) of less than or equal to 13.4%; Rvis (interior) of less than or equal to 13.9%; TSET of less than or equal to 32.5%; TSER (exterior) of greater than or equal to 29.1%; TSER (interior) of greater than or equal to 30.8%; SC of less than or equal to 0.43; SHGC of less than or equal to 0.38; LSG Ratio of greater than or equal to 1.84; and U-Value of less than or equal to 0.30 Btu/hr-ft2-° F.

15. The coated substrate according to claim 1, further comprising a protective overcoat overlying the third dielectric layer.

16. A coated substrate comprising:
a. a glass substrate;
b. a first dielectric layer having a total thickness greater than 290 Å overlying the substrate comprising:
i. a layer of zinc stannate overlying the substrate; and
ii. a layer of zinc oxide overlying the layer of zinc stannate;
c. a first silver layer having a thickness ranging from 100 Å to 130 Å overlying the first dielectric layer;
d. a first layer of titanium containing material having a thickness ranging from 0.5 Å to 60 Å overlying the first silver layer;
e. a second dielectric layer having a thickness ranging from 680 Å to 800 Å overlying the first layer of titanium containing material comprising:
i. a layer of zinc oxide overlying the layer of titanium containing material;
ii. a layer of zinc stannate overlying the layer of zinc oxide; and
iii. a layer of zinc oxide overlying the layer of zinc stannate;
f. a second silver layer having a thickness ranging from 115 Å to 150 Å overlying the second dielectric layer;
g. a second layer of titanium containing material having a thickness ranging from 0.5 Å to 60 Å overlying and in contact with the second silver layer; and
h. a third dielectric layer having a thickness ranging from 190 Å to 380 Å overlying the second layer of titanium containing material comprising:
i. a layer of zinc oxide overlying the second layer of titanium containing material; and
ii. a layer of zinc stannate overlying the layer of zinc oxide of the third dielectric layer,
wherein there is no NiOx layer between the first infrared-reflective metal layer and the second dielectric layer or over the second infrared-reflective metal.

17. The coated substrate according to claim 16 wherein when the coated substrate is placed in an insulating glass (IG) unit having a configuration as described in the following manner: an outboard light pane having a major surface made of 0.223 inch thick clear glass spaced 0.5 inch apart from and facing an inboard light pane made of clear glass having a nominal thickness of 0.223 inch; a space between the light panes filled with air; and the coating applied on the major surface of the outboard light pane nearest to and facing the inboard light pane; and the IG unit exhibits at least one of the following properties: Tvis of greater than or equal to 68.2%; Rvis (exterior) of less than or equal to 13.4%; Rvis (interior) of less than or equal to 13.9%; TSET of less than or equal to 32.5%; TSER (exterior) of greater than or equal to 29.1%; TSER (interior) of greater than or equal to 30.8%; SC of less than or equal to 0.43; SHGC of less than or equal to 0.38; LSG Ratio of greater than or equal to 1.84; and U-Value of less than or equal to 0.30 Btu/hr-ft2-° F.

18. A method for making a coated substrate comprising:
a. depositing a first dielectric layer having a thickness greater than 290 Å over the substrate;
b. depositing a first infrared-reflective metal layer having a thickness ranging from 100 Å to 130 Å over the first dielectric layer;
c. depositing a first primer layer selected from a titanium containing material, -a zirconium containing material, an aluminum containing material, a hafnium containing material, a copper containing material, a niobium containing material, a tantalum containing material, a vanadium containing material, and an indium containing material having a thickness ranging from 0.5 Å to 60 Å over the first infrared-reflective metal layer;
d. depositing a second dielectric layer having a thickness ranging from 680 Å to 800 Å over the first primer layer;
e. depositing a second infrared-reflective metal layer having a thickness ranging from 115 Å to 150 Å over the second dielectric layer;
f. depositing a second primer layer selected from a titanium containing material, a zirconium containing material, an aluminum containing material, a hafnium containing material, a copper containing material, a niobium containing material, a tantalum containing material, a vanadium containing material, and an indium containing material having a thickness ranging from 0.5 Å to 60 Å over and in direct contact with the second infrared-reflective metal layer; and
g. depositing a third dielectric layer having a thickness ranging from 190 Å to 380 Å over the second primer layer, wherein no NiOx layer is deposited between the first infrared-reflective metal layer and the second dielectric layer or over the second infrared-reflective metal.

19. The method according to claim 18 wherein depositing the first dielectric layer comprises depositing a material having a refractive index greater than or equal to 2 in the visible portion of the electromagnetic spectrum.

20. The method according to claim 18 wherein depositing the first dielectric layer comprises:
depositing a major film selected from zinc oxide, tin oxide, zinc/tin oxide, zinc stannate, zinc aluminum oxide, indium oxide, indium tin oxide, titanium oxide, tantalum oxide, bismuth oxide, silicon nitride, aluminum nitride as well as alloys and mixtures thereof over the substrate; and
depositing a minor film selected from zinc oxide, tin oxide, zinc/tin oxide, zinc stannate, zinc aluminum oxide, indium oxide, indium tin oxide, titanium oxide, tantalum oxide, bismuth oxide, silicon nitride, aluminum nitride as well as alloys and mixtures thereof over the major film.

21. The method according to claim 20 wherein the deposited minor film is zinc oxide.

22. The method according to claim 18 wherein depositing the second dielectric layer comprises:
a. depositing a lower minor film selected from zinc oxide, tin oxide, zinc/tin oxide, zinc stannate, zinc aluminum oxide, indium oxide, indium tin oxide, titanium oxide, tantalum oxide, bismuth oxide, silicon nitride, aluminum nitride as well as alloys and mixtures thereof over the first primer film;
b. depositing a major film selected from zinc oxide, tin oxide, zinc/tin oxide, zinc stannate, zinc aluminum oxide, indium oxide, indium tin oxide, titanium oxide, tantalum oxide, bismuth oxide, silicon nitride, aluminum nitride as well as alloys and mixtures thereof over the lower minor film; and
c. depositing an upper minor film selected from zinc oxide, tin oxide, zinc/tin oxide, zinc stannate, zinc aluminum oxide, indium oxide, indium tin oxide, titanium oxide, tantalum oxide, bismuth oxide, silicon nitride, aluminum nitride as well as alloys and mixtures thereof over the major film.

23. The method according to claim 22 wherein the deposited lower and upper minor film are comprised of zinc oxide.

24. The method according to claim 18 wherein depositing the third dielectric layer over the second primer layer comprises:
a. depositing a minor film selected from zinc oxide, tin oxide, zinc/tin oxide, zinc stannate, zinc aluminum oxide, indium oxide, indium tin oxide, titanium oxide, tantalum oxide, bismuth oxide, silicon nitride, aluminum nitride as well as alloys and mixtures thereof over the second primer layer; and
b. depositing a major film selected from zinc oxide, tin oxide, zinc/tin oxide, zinc stannate, zinc aluminum oxide, indium oxide, indium tin oxide, titanium oxide, tantalum oxide, bismuth oxide, silicon nitride, aluminum nitride as well as alloys and mixtures thereof over the minor film of the third dielectric layer.

25. The method according to claim 24 wherein the deposited minor film is zinc oxide.

26. The method of claim 18 further comprising heating the coated substrate.
